(19) United States
(12) Patent Application Publication
(10) Pub. No.: US 2013/0337808 A1
(43) Pub. Date: Dec. 19, 2013

(54) FACILITATING SERVICE ACCESS FOR MULTI-MODE DEVICES

(71) Applicant: QUALCOMM INCORPORATED, San Diego, CA (US)

(72) Inventors: Suli Zhao, San Diego, CA (US); Ajith T. Payapilly, San Diego, CA (US); Srinivasan Balasubramanian, San Diego, CA (US); Shrawan K. Khatri, San Diego, CA (US); Hariharan Sukumar, San Diego, CA (US)

(73) Assignee: QUALCOMM Incorporated, San Diego, CA (US)

(21) Appl. No.: 13/763,510

(22) Filed: Feb. 8, 2013

Related U.S. Application Data
(60) Provisional application No. 61/660,398, filed on Jun. 15, 2012.

(51) Int. Cl. H04W 60/00

(52) U.S. Cl. CPC H04W 60/00
USPC 455/435.3; 455/435.2

(57) ABSTRACT

A method for wireless communication is disclosed. A first attach access point name candidate is selected from an attach access point name list. A long term evolution attach is performed using the selected attach access point name. It is determined whether the long term evolution attach succeeds. A next attach access point name candidate is selected from the attach access point name list if the long term evolution attach using the first attach access point name candidate fails and causes a change of attach access point name.

### CROSS-REFERENCE TO RELATED APPLICATIONS

This application is related to and claims priority from U.S. Provisional Patent Application Ser. No. 61/660,398, filed Jun. 15, 2012, for “APPARATUS AND METHODS TO FACILITATE SERVICE ACCESS FOR MULTI-MODE DEVICES.”

### TECHNICAL FIELD

The present disclosure relates generally to wireless communication systems. More specifically, the present disclosure relates to systems and methods for facilitating service access for multi-mode devices.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Some electronic devices (e.g., cellular phones, smartphones, computers, etc.) communicate with other electronic devices. For example, a wireless communication device (e.g., cellular phone, smartphone, etc.) may wirelessly communicate with a base station and vice-versa. This may enable the wireless communication device to access and/or communicate voice, video, data and so on.

Some electronic devices are capable of communicating using multiple different technologies. These electronic devices may switch the technology used when another technology becomes available (such as from a different base station) or when circumstances warrant a switch (such as a need for a higher data transfer rate). These electronic devices may need to adjust communication settings that are used when such a switch occurs. As can be seen from this discussion, systems and methods that improve the switching capabilities of the electronic devices may be beneficial.

### BRIEF DESCRIPTION OF THE DRAWINGS

FIG. 1 shows a wireless communication system with multiple wireless devices;

FIG. 2 is a block diagram illustrating the network architecture for evolved High Rate Packet Data (eHRPD);

FIG. 3 is a call flow diagram illustrating LTE attach procedures;

FIG. 4 is a block diagram illustrating an APN attach module for use in the present systems and methods;

FIG. 5 is a flow diagram of a method for maintaining an attach APN list of attach APN candidates during an LTE attach when LTE detach is preferred;

FIG. 6 is a flow diagram of a method for maintaining an attach APN list of attach APN candidates during an LTE attach when LTE detach is not preferred;

FIG. 7 is a flow diagram of a method for obtaining all parameters in a mandatory parameters list for a profile;

FIG. 8 is a flow diagram of a method for initiating PDN level synchronization; and

FIG. 9 shows part of a hardware implementation of an apparatus for executing the LTE attach and PDN connection setup methods described herein.

### DETAILED DESCRIPTION

Today's 4G devices use a simplistic approach to attaching and retaining PDN connections on LTE or eHRPD. For attaching to LTE, one particular APN is configured to be the initial attach APN. If the attach procedure succeeds, the device is able to access LTE. If the attach procedure fails, the device has to fall down to 3G and remain there for a period of time. Furthermore, the network may not configure certain parameters or IP addresses, resulting in the deletion of a PDN connection. As described herein, a sophisticated algorithm may be used by a device to determine which APN the device should try to attach to for different scenarios. In addition, the policies for deciding to retain a PDN connection are described. The net result is that the device is able obtain access to an LTE network (and remain on the network), thereby retaining 4G services for a longer duration of time. This may be accomplished by the device maintaining a list of attach APN candidates and the mandatory parameters for the attach APN candidates.

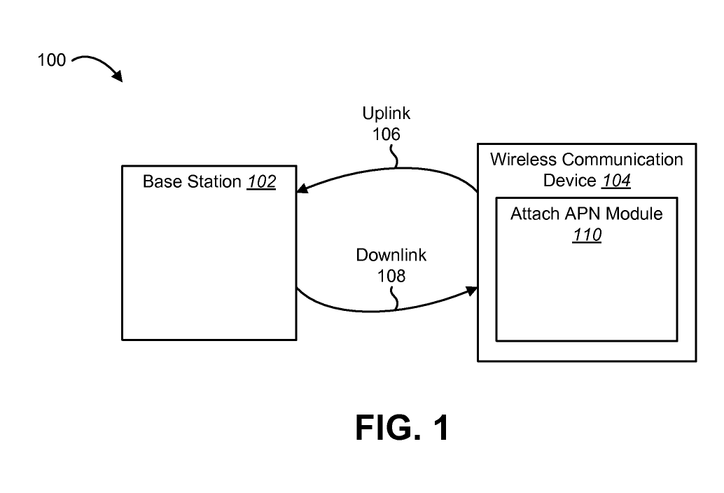

FIG. 1 shows a wireless communication system 100 with multiple wireless devices. Wireless communication systems 100 are widely deployed to provide various types of communication content such as voice, data and so on. A wireless device may be a base station 102 or a wireless communication device 104. A wireless communication device 104 may be configured to receive Long Term Evolution (LTE) services via an LTE attach procedure. The LTE attach procedure is a specific set of procedures that allow a wireless communication device to attach to a network and obtain an Internet protocol (IP) address to facilitate Long Term Evolution (LTE) communications. The LTE attach procedure allows for establishment of packet data network (PDN) connectivity to a specific access point name (APN) (referred to as the attach APN). As used herein, LTE refers to Long Term Evolution, APN refers to access point name and PDN refers to packet data network.

A base station 102 is a station that communicates with one or more wireless communication devices 104. A base station 102 may also be referred to as, and may include some or all of the functionality of, an access point, a broadcast transmitter, a NodeB, an evolved NodeB, etc. The term “base station” will be used herein. Each base station provides communication coverage for a particular geographic area. A base station may provide communication coverage for one or more wireless communication devices 104. The term “cell” can refer to a base station 102 and/or its coverage area depending on the context in which the term is used.

Communications in a wireless communication system 100 (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one or multiple base stations 102 on the downlink 108 and/or uplink 106 at any given moment. The downlink 108 (or forward link) refers to the communication link from a base station 102 to a wireless communication device 104, and the uplink 106 (or reverse link) refers to the communication link from a wireless communication device 104 to a base station 102.

The wireless communication device 104 may include an attach APN module 110. The attach APN module 110 may allow the wireless communication device 104 to obtain LTE services from a network (e.g., using 4G services) by camping on the LTE network. The attach APN module 110 may allow the wireless communication device 104 to obtain 4G services that are provided by APNs other than the statically configured APN for the wireless communication device 104. For example, the attach APN module 110 may allow the wireless communication device 104 to obtain services from an Internet APN. The attach APN module 110 may allow the wireless communication device 104 to request/maintain the parameters necessary for multiple APNs.

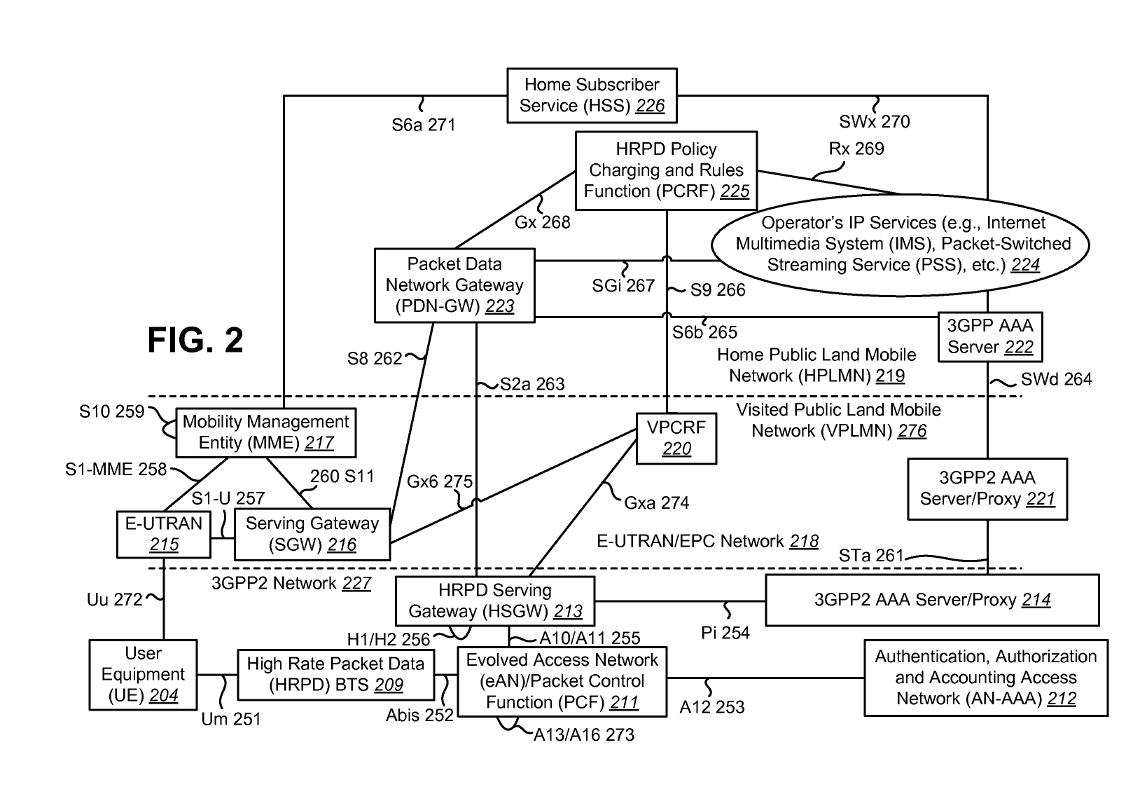

FIG. 2 is a block diagram illustrating the network architecture for evolved High Rate Packet Data (eHRPD). The network architecture may be a wireless communication system 100. In general, a wireless communication device 104 that is capable of connecting to an Enhanced Packet Core (EPC) network 218 (i.e., a core network that supports the evolved high rate packet data (eHRPD) and Long Term Evolution (LTE) technologies) may be referred to as either a user equipment (UE) 204 or an enhanced access terminal (eAT). A wireless communication device 104 that is only capable of connecting to legacy 3GPP2 networks 227 such as 1x or high rate packet data (HRPD), and is not capable of connection to the Enhanced Packet Core (EPC) network 218 may be referred to as an access terminal (AT). A user equipment (UE) 204 may also be capable of connecting to legacy 1x/HRPD networks (e.g., a 3GPP2 network 227).

A user equipment (UE) 204 has the ability to obtain services from multiple APNs via multiple packet data network gateways (PDN-GWs) 223. Such a connection from a user equipment (UE) 204 to a packet data network gateway (PDN-GW) 223 is called a PDN connection. For each PDN connection, a user equipment (UE) 204 is assigned one or two IP addresses by the packet data network Gateway (PDN-GW) 223.

The user equipment (UE) 204 may be assigned a single IPv4 address, a single IPv6 address or both an IPv4 address and an IPv6 address, depending on the capability and type of services offered by the APN. A PDN connection between the user equipment (UE) and a packet data network gateway (PDN-GW) 223 is not a direct connection. In evolved High Rate Packet Data (eHRPD), the HRPD serving gateway (HSGW) 213 communicates with the user equipment (UE) 204 and manages every PDN connection with the user equipment (UE) 204. In Long Term Evolution (LTE), a serving gateway (SGW) 216 communicates with the user equipment (UE) 204 via the evolved UMTS Terrestrial Radio Access network (E-UTRAN) 215 (i.e., the serving gateway (SGW) 216 communicates with the E-UTRAN 215 using an S1-U interface 257 and the E-UTRAN 215 communicates with the user equipment (UE) 204 using a Uu interface 272) and manages every PDN connection with the user equipment (UE) 204. The HRPD Serving Gateway (HSGW) 213 (or serving gateway (SGW) 216) then communicates with the packet data network gateway (PDN-GW) 223 for each PDN connection.

In a 3GPP2 network 227, the user equipment (UE) 204 may communicate with an HRPD base transceiver station (BTS) 209 via a Um interface 251. The HRPD base transceiver station (BTS) 209 may communicate with an evolved access network (eAN)/Packet Control Function (PCF) 211 via an Abis interface 252. The evolved access network (eAN)/Packet Control Function (PCF) 211 may then communicate with the authentication, authorization and accounting access network (AN-AAA) 212 via an A12 interface 253. The evolved access network (eAN)/Packet Control Function (PCF) 211 may further communicate with an HRPD Serving Gateway (HSGW) 213 via an A10/A11 interface 255. The HRPD Serving Gateway (HSGW) 213 may communicate with a 3GPP2 AAA (authentication, authorization and accounting) server/proxy 214 via a Pi interface 254. The H1/H2 interface 256 may be the interface between two HRPD Serving Gateways (HSGWs) 213. The A13/A16 interface 273 may be the interface between two evolved access networks (eANs)/Packet Control Functions (PCFs) 211.

The E-UTRAN/EPC network 218 may include a 3GPP2 AAA server/proxy 221 that communicates with the 3GPP2 AAA server/proxy 214 of the 3GPP2 network 227 via an STa interface 261. The E-UTRAN/EPC network 218 may also include a visited Policy Charging and Rules Function (vPCRF) 220, a serving gateway (SGW) 216, a Mobility Management Entity (MME) 217 and a E-UTRAN 215. The vPCRF 220 may communicate with the HSGW 213 via a Gxa interface 274. The vPCRF 220 may communicate with the serving gateway (SGW) 216 via a Gxc interface 275. The serving gateway (SGW) 216 may communicate with the E-UTRAN 215 via a S1-U interface 257. The serving gateway (SGW) 216 may communicate with the Mobility Management Entity (MME) 217 via an S11 interface 260. The E-UTRAN 215 may communicate with the Mobility Management Entity (MME) 217 via a S1-MME interface 258. The Mobility Management Entity (MME) 217 may communicate with other Mobility Management Entities (MMEs) 217 via an S10 interface 259.

Communications between a visited public land mobile network (VPLMN) 276 and a home PLMN 219 are shown. The home PLMN (HPLMN) network 219 may include a Home Subscriber Service (HSS) 226, one or more packet data network gateways (PDN-GWs) 223, an HRPD policy charging and rules function (hPCRF) 225, operator IP services 224 (e.g., Internet Multimedia System (IMS), packet-switched streaming service (PSS)) and a 3GPP AAA (authentication, authorization and accounting) server 222.

The packet data network gateway (PDN-GW) 223 may communicate with the HRPD serving gateway (HSGW) 213 via an S2a interface 263, with the HRPD policy charging and rules function (hPCRF) 225 via a Gx interface 268, with the operator IP services 224 via an SGi interface 267, with the serving gateway (SGW) 216 via an s8 interface 262 and with the 3GPP AAA (authentication, authorization and accounting) server 222 via an S6b interface 265. The HRPD policy charging and rules function (hPCRF) 225 may communicate with the vPCRF 220 via an s9 interface 266 and with the operator IP services 224 via an Rx interface 269. The 3GPP AAA (authentication, authorization and accounting) server 222 may communicate with the 3GPP2 AAA (authentication, authorization and accounting) server/proxy 221 via an SWd interface 264 and with the Home Subscriber Service (HSS) 226 via an SWx interface 270. The Home Subscriber Service (HSS) 226 may communicate with the Mobility Management Entity (MME) 217 via an S6a interface 271.

Today's 4G devices use a simplistic approach to attaching and retaining PDN connections on LTE or eHRPD. For attaching to LTE, one particular APN is configured to be the initial attach APN. If the attach procedure succeeds, the device is able to access LTE. If the LTE attach fails for some reason, the device has to fall down to 3G and remain there for a period of time, reducing the user experience. Another issue is that after an LTE attach or PDN connection succeeds, there are a set of mandatory parameters that the network is supposed to configure. If one or more of the parameters is not configured, the behavior of the user equipment (UE) 204 is not defined in the standards. The net result is that the end-user is not able to gain access to 4G services, which could have been obtained if a more sophisticated approach was followed. This is an actual problem being faced in commercial LTE networks today. An alternate network based solution for the selection of the APN is for the user equipment (UE) 204 to just specify NULL in the attach request and have the network assign the APN and inform the user equipment (UE) 204. The problem with this network based approach is that many operators do not support this option on the network. The network operators expect the user equipment (UE) 204 to specify the APN that the user equipment (UE) 204 wants to connect to.

Current user equipments (UEs) 204 follow a simplistic approach where the user equipment (UE) 204 always tries one particular APN to attach to LTE. If the LTE attach succeeds, the user equipment (UE) 204 is able to obtain 4G services. If the LTE attach fails, the user equipment (UE) 204 is not able to obtain 4G services for an extended period of time. Other problems are described that deal with PDN connection deletion due to the network not configuring certain parameters or IP addresses. In the present systems and methods, a sophisticated algorithm and architecture determines which APN the user equipment (UE) 204 should try to attach to on LTE for different scenarios and the policies for deciding to retain a PDN connection. The net result is that the user equipment (UE) 204 is able to get access to and remain on an LTE network (thereby obtaining 4G services) for a longer duration of time. The proposed solutions can also apply to other radio technologies that access the Enhanced Packet Core (EPC) network 218 (e.g. eHRPD).

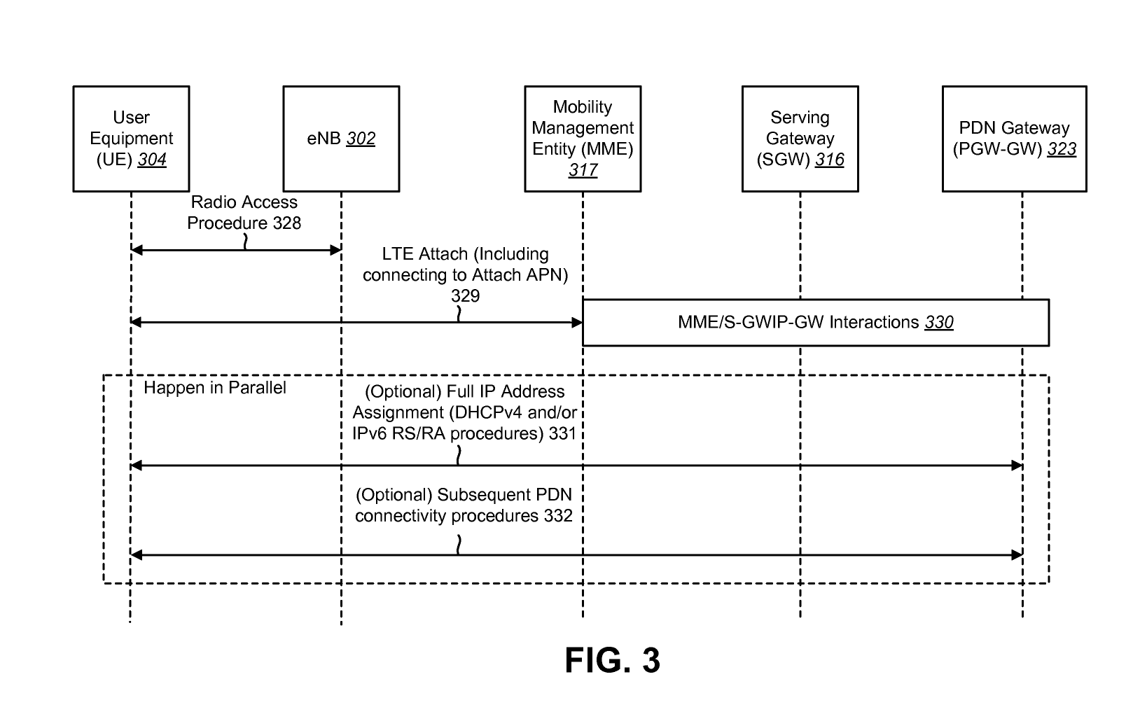

FIG. 3 is a call flow diagram illustrating LTE attach procedures. A radio access procedure 328 may occur between a user equipment (UE) 304 and an eNB 302. The user equipment (UE) 304 may then perform an LTE attach 329 (including connecting to the attach APN) with a Mobility Management Entity (MME) 317. In one configuration, the user equipment (UE) 304 may perform an LTE attach 329 using an antenna. During the LTE attach, the Mobility Management Entity (MME) 317, the serving gateway (SGW) 316 and the PDN gateway (PGW-GW) 323 may interact with each other (referred to as MME/S-GWIP-GW interactions 330). The standards allow a full IP address assignment 331 (DHCPv4 and/or IPv6 RS/RA procedures) between the user equipment (UE) 304 and the PDN gateway (PGW-GW) 323 to happen in parallel with subsequent PDN connectivity procedures 332 between the user equipment (UE) 304 and the PDN gateway (PGW-GW) 323. Both the full IP address assignment 331 and the subsequent PDN connectivity procedures 332 are optional.

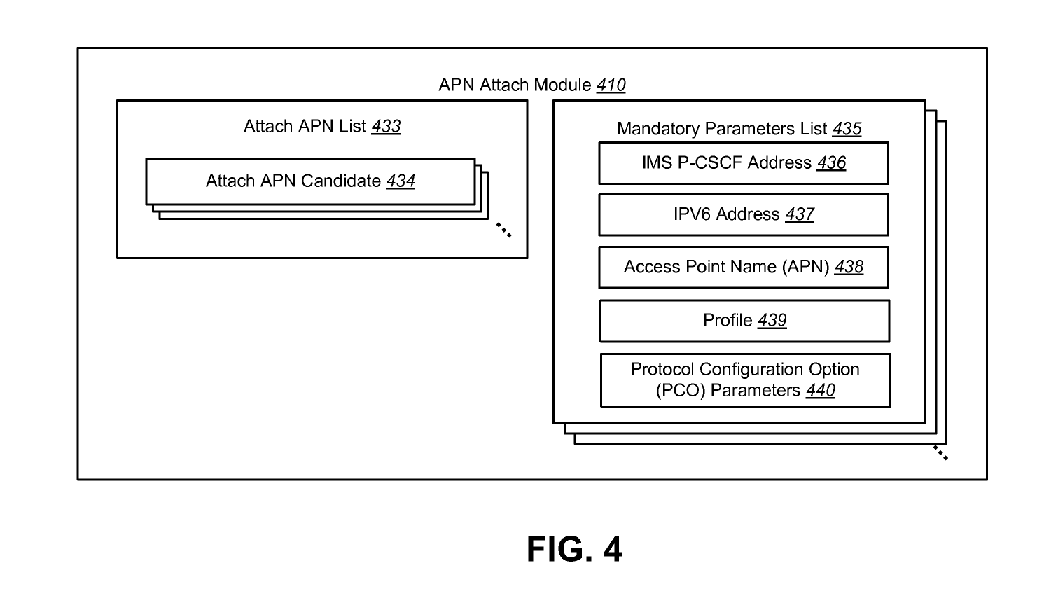

FIG. 4 is a block diagram illustrating an APN attach module 410 for use in the present systems and methods. The APN attach module 410 may be part of a user equipment (UE) 204. If the user equipment (UE) 204 is operating using eHRPD, by connecting to an APN, the user equipment (UE) 204 may access the Enhanced Packet Core (EPC) network 218 and receive data services. The PDN connection procedures may be independent of the attachment over eHRPD. The standards allow the user equipment (UE) 204 to operating using eHRPD without PDN connections. This is different from the requirements of an LTE network. Thus, when the described systems and methods are applied to eHRPD, only the PDN disconnection applies.

The APN attach module 410 may include an attach APN list 433. The attach APN list 433 may include multiple attach APN candidates 434 listed in priority order. The APN attach module 410 may also include a mandatory parameters list 435 for each APN 438. The mandatory parameters list 435 may include the important APN parameters, such as the IMS P-CSCF address 436 and the IPv6 address 437 (for each APN 438).

In one configuration, the mandatory parameters list 435 may have finer granularity (e.g., one mandatory parameters list 435 per profile 439 instead of one mandatory parameters list 435 per APN 438). Thus, there may be multiple mandatory parameters lists 435 for one APN 438. A mandatory parameters list 435 may include the important APN parameters for the applications that use the profile 439. When requesting a PDN connection, the user equipment (UE) 204 may request all the protocol configuration option (PCO) parameters 440 listed in all the mandatory parameters lists 435 corresponding to the APN 438, whether the protocol configuration option (PCO) parameters 440 are required by the application initially requesting the PDN connection or not. If the LTE attach is based on one profile 439 and the user equipment (UE) 204 maintains a mandatory parameters list 435 for each profile 439, the user equipment (UE) 204 may request all protocol configuration option (PCO) parameters 440 listed in all mandatory parameters lists 435 corresponding to an APN 438 when the LTE attach is triggered.

If any of the parameters in the mandatory parameters list 440 of the current profile 439 have not been assigned by the network, the user equipment (UE) 204 may disconnect from the PDN. This may apply to PDN connection procedures over other Enhanced Packet Core (EPC) networks 218 (such as eHRPD).

Current user equipments (UEs) 204 in the market are statically configured to have one particular APN as the attach APN (e.g., the 3G IP multimedia subsystem (IMS) APN). If the user equipment (UE) 204 fails to connect to this APN during LTE attach, the user equipment (UE) 204 cannot camp on LTE to receive 4G services. Network entities may be immature when the carrier initially launches new networks. Upon encountering failures of the specific attach APN, 4G LTE capable user equipments (UEs) 204 may disable LTE and behave like 3G devices until the specific attach APN failure is recovered (and the user equipment (UE) 204 makes an attempt). Such behavior may prevent 4G subscribers from using other 4G services provided by other APNs (e.g, an Internet APN).

Thus, the user equipment (UE) 204 may maintain an attach APN list 433 with the attach APN candidates 434. The user equipment (UE) 204 may also allow the operator to provision the attach APN list 433. The user equipment (UE) 204 may determine to change to another APN after failing an LTE attach due to some failure reason (e.g., PDN Connectivity Rejection with a certain cause code indicating PDN level failure reasons). The user equipment (UE) 204 may also determine to reset the attach APN to the first item (e.g., the first attach APN candidate 434) in the attach APN list 433 upon acquiring/reacquiring an LTE system or upon successfully attaching to LTE using other APNs.

The user equipment (UE) 204 may fail to obtain certain important parameters from the network during an LTE attach (e.g., the proxy call session control function (P-CSCF) address 436 for IP multimedia subsystem (IMS) APNs). Some user equipments (UEs) 204 may still consider such an LTE attach successful. Thus, the user equipment (UE) 204 may retain the PDN connection (unless all applications using this PDN connection indicate that this PDN is not needed) but the user equipment (UE) 204 may not be able to receive certain services (e.g., if the proxy call session control function (P-CSCF) address is not assigned for an IP multimedia subsystem (IMS) APN, the user equipment (UE) 204 cannot receive IP multimedia subsystem (IMS) services). The important parameters can be different for different APNs 438 used for the LTE attach.

The user equipment (UE) 204 may also fail to complete the IP address assignment. For a dual-IP PDN, the network may assign one IP type or both IP types. It may not be clear to the user equipment (UE) 204 whether to stay on the LTE (or retain the PDN connection) if one IP type is not assigned. Furthermore, the user equipment (UE) 204 may not know when to proceed with a subsequent PDN connection. The standard may allow router solicitation/router advertisement (RS/RA) or a DHCPv4 procedure and subsequent PDN connection procedures to happen in parallel. Also, the mandatory IP address(es) may be different for different APNs 438.

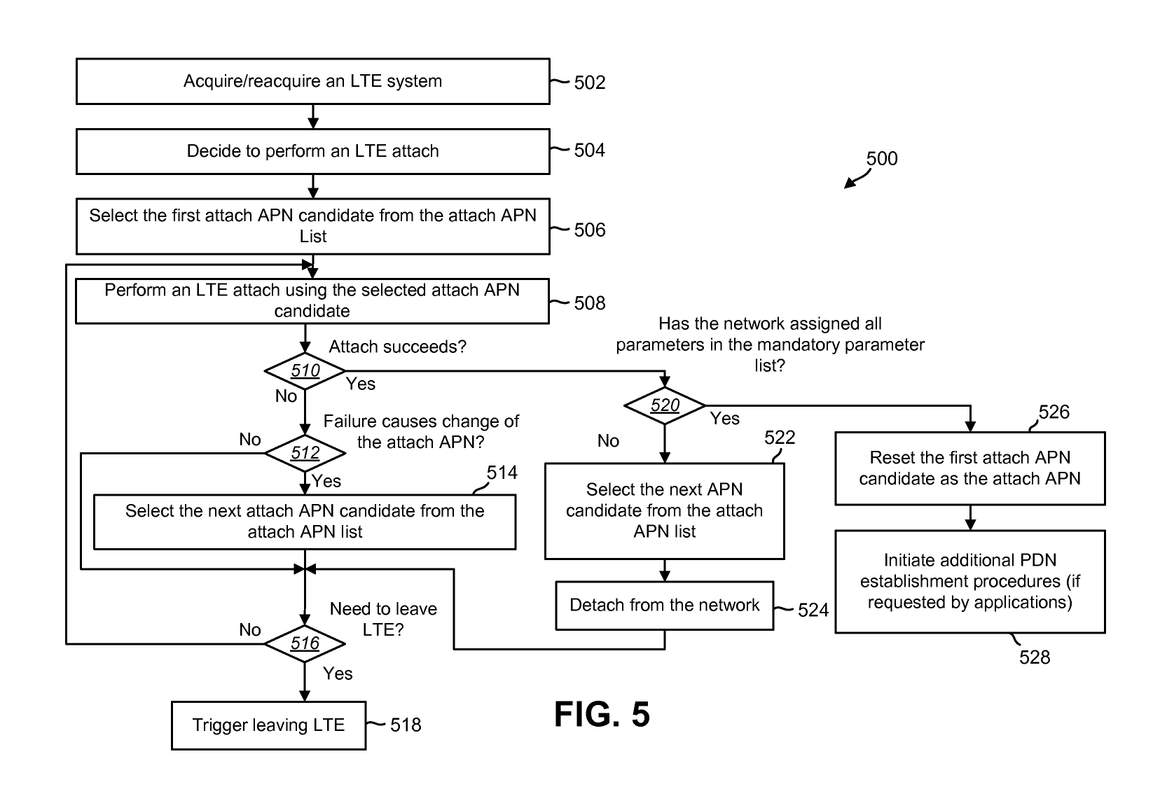

FIG. 5 is a flow diagram of a method 500 for maintaining an attach APN list 433 of attach APN candidates during an LTE attach when LTE detach is preferred. The method 500 may be performed by a user equipment (UE) 204. The user equipment (UE) 204 may proceed with subsequent PDN connection establishment (if requested by applications) only if all parameters in the mandatory parameters list 435 have been assigned by the network. If the user equipment (UE) 204 fails to obtain all the parameters in the mandatory parameters list 435, the user equipment (UE) 204 may detach from the network and change to a different APN for a subsequent LTE attach.

The user equipment (UE) 204 may acquire 502 (or reacquire) an LTE system. The user equipment (UE) 204 may decide 504 to perform an LTE attach. The user equipment (UE) 204 may select 506 the first attach APN candidate 434 from the attach APN list 433. In one configuration, the user equipment (UE) 204 may select 506 the first attach APN candidate 434 from the attach APN list 433 using a processor. In another configuration, the user equipment (UE) 204 may select 506 the first attach APN candidate 434 from the attach APN list 433 using memory. The user equipment (UE) 204 may then perform 508 an LTE attach using the selected attach APN candidate 434. The user equipment (UE) 204 may determine 510 whether the LTE attach was successful. In one configuration, the user equipment (UE) 204 may determine 510 whether the LTE attach was successful using a processor.

If the LTE attach was not successful, the user equipment (UE) 204 may determine 512 whether the failure causes a change of the attach APN. If the failure causes a change of the attach APN, the user equipment (UE) 204 may select 514 the next attach APN candidate 434 from the attach APN list 433. For example, the user equipment (UE) 204 may select 514 the next attach APN candidate 434 from the attach APN list 433 using a processor and/or memory. In one configuration, the user equipment (UE) 204 may reevaluate the attach APN list 433 due to network response or provisioning. In other words, based on the network response, the user equipment (UE) 204 may update the attach APN candidates 434 of the attach APN list 433.

The user equipment (UE) 204 may then determine 516 whether the user equipment (UE) 204 needs to leave LTE. If the failure does not cause a change of attach APN, the user equipment (UE) 204 may still determine 516 whether the user equipment (UE) 204 needs to leave LTE. If it is determined that the user equipment (UE) 204 does not need to leave LTE, the user equipment (UE) 204 may again perform 508 an LTE attach using the selected attach APN candidate 434. If it is determined that the user equipment (UE) 204 does need to leave LTE, the user equipment (UE) 204 may trigger 518 leaving LTE.

If the LTE attach succeeds, the user equipment (UE) 204 may determine 520 whether the network has assigned all the parameters in the mandatory parameters list 435. If the network has assigned all the parameters in the mandatory parameters list 435, the user equipment (UE) 204 may reset 526 the first attach APN candidate 434 in the attach APN list 433 as the attach APN. The user equipment (UE) 204 may then be allowed to initiate 528 additional PDN establishment procedures (if requested by applications).

If the network has not assigned all the parameters in the mandatory parameters list 435, the user equipment (UE) 204 may select 522 the next attach APN candidate 434 from the attach APN list 433. The user equipment (UE) 204 may next detach 524 from the network. The user equipment (UE) 204 may then determine 516 whether the user equipment (UE) 204 needs to leave LTE. If it is determined that the user equipment (UE) 204 does not need to leave LTE, the user equipment (UE) 204 may again perform 508 an LTE attach using the selected APN. If it is determined that the user equipment (UE) 204 does need to leave LTE, the user equipment (UE) 204 may trigger 518 leaving LTE.

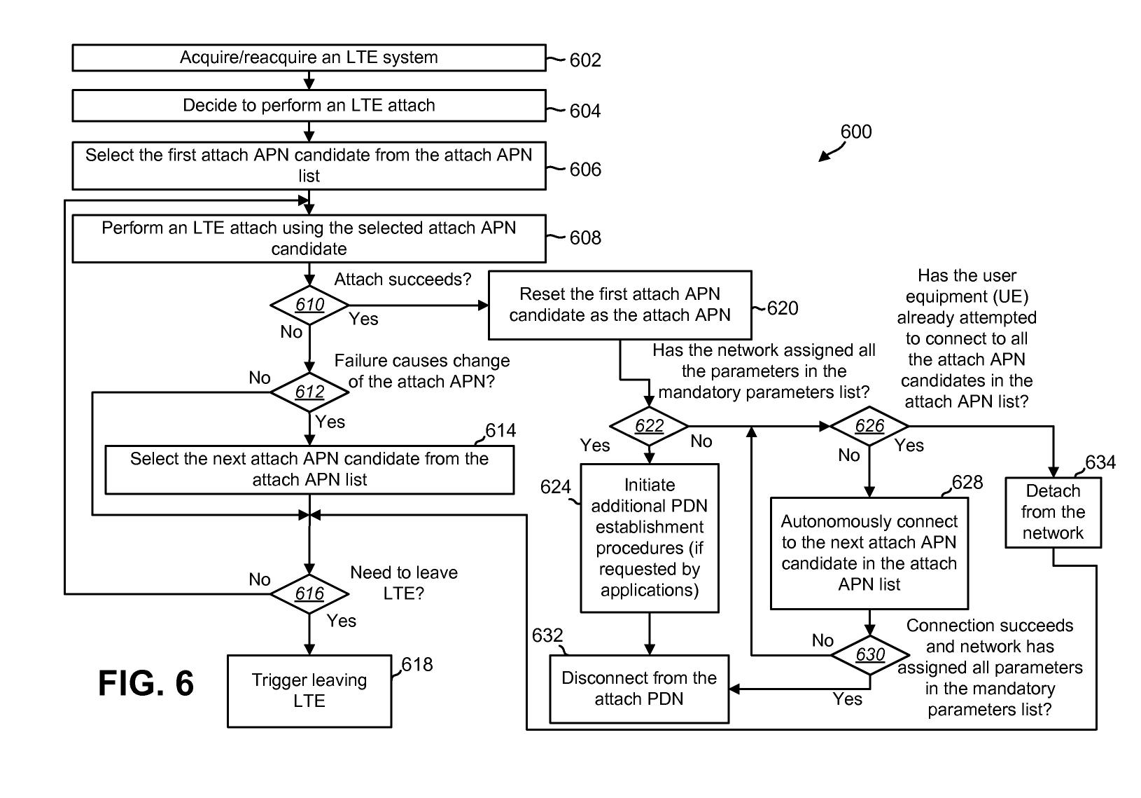

FIG. 6 is a flow diagram of a method 600 for maintaining an attach APN list 433 of attach APN candidates 434 during an LTE attach when LTE detach is not preferred. The method 600 may be performed by a user equipment (UE) 204. If any of the parameters in the mandatory parameters list 435 have not been assigned by the network, the user equipment (UE) 204 may autonomously bring up the PDN connection to the next attach APN candidate 434 in the attach APN list 433. After this PDN connection is successfully established and all the parameters in the mandatory parameters list 435 for this attach APN candidate 434 have been obtained, the user equipment (UE) 204 may disconnect from the first PDN. The user equipment (UE) 204 possibly throttles future connections to that APN for a period of time. The method 600 of FIG. 6 has the same effect as the method 500 of FIG. 5 but with less signaling overhead.

The user equipment (UE) 204 may acquire 602 (or reacquire) an LTE system. The user equipment (UE) 204 may decide 604 to perform an LTE attach. The user equipment (UE) 204 may select 606 the first attach APN candidate 434 from the attach APN list 433. The user equipment (UE) 204 may then perform 608 an LTE attach using the selected attach APN candidate 434. The user equipment (UE) 204 may determine 610 whether the LTE attach was successful.

If the LTE attach was not successful, the user equipment (UE) 204 may determine 612 whether the failure causes a change of the attach APN. If the failure causes a change of the attach APN, the user equipment (UE) 204 may select 614 the next attach APN candidate 434 from the attach APN list 433. The user equipment (UE) 204 may then determine 616 whether the user equipment (UE) 204 needs to leave LTE. If the failure does not cause a change of attach APN, the user equipment (UE) 204 may determine 616 whether the user equipment (UE) 204 needs to leave LTE. If it is determined that the user equipment (UE) 204 does not need to leave LTE, the user equipment (UE) 204 may again perform 608 an LTE attach using the selected attach APN candidate 434. If it is determined that the user equipment (UE) 204 does need to leave LTE, the user equipment (UE) 204 may trigger 618 leaving LTE.

If the LTE attach succeeds, the user equipment (UE) 204 may reset 620 the first attach APN candidate 434 as the attach APN. The user equipment (UE) 204 may then determine 622 whether the network has assigned all the parameters in the mandatory parameters list 435 for the attach APN. If the network has assigned all the parameters in the mandatory parameters list 435 for the attach APN, the user equipment (UE) 204 may be allowed to initiate additional PDN establishment procedures (if requested by applications).

If the network has not assigned all the parameters in the mandatory parameters list 435 for the attach APN, the user equipment (UE) 204 may determine 626 whether the user equipment (UE) 204 has already attempted to connect to all the attach APN candidates 434 in the attach APN list 433. If the user equipment (UE) 204 has already attempted to connect to all the attach APN candidates 434 in the attach APN list 433, the user equipment (UE) 204 may detach 634 from the network. The user equipment (UE) 204 may then determine 616 whether the user equipment (UE) 204 needs to leave LTE. If it is determined that the user equipment (UE) 204 does not need to leave LTE, the user equipment (UE) 204 may again perform an LTE attach using the selected attach APN candidate 434. If it is determined that the user equipment (UE) 204 does need to leave LTE, the user equipment (UE) 204 may trigger 618 leaving LTE.

If the user equipment (UE) 204 determines that the user equipment (UE) 204 has not already attempted to connect to all attach APN candidates 434 in the attach APN list 433, the user equipment (UE) 204 may autonomously connect 628 to the next attach APN candidate 434 in the attach APN list 433. The user equipment (UE) 204 may then determine 630 whether the connection has succeeded and the network has assigned all the parameters in the mandatory parameters list 435. If the connection has succeeded and the network has assigned all the parameters in the mandatory parameters list 435, the user equipment (UE) 204 may disconnect 632 from the attach PDN. The user equipment (UE) 204 may then be allowed to initiate 624 additional PDN establishment procedures (if requested by applications). If the connection has not succeeded and/or the network has not assigned all the parameters in the mandatory parameters list 435, the user equipment (UE) 204 may again determine 626 whether the user equipment (UE) has already attempted to connect to all the attach APN candidates 434 in the attach APN list 433.

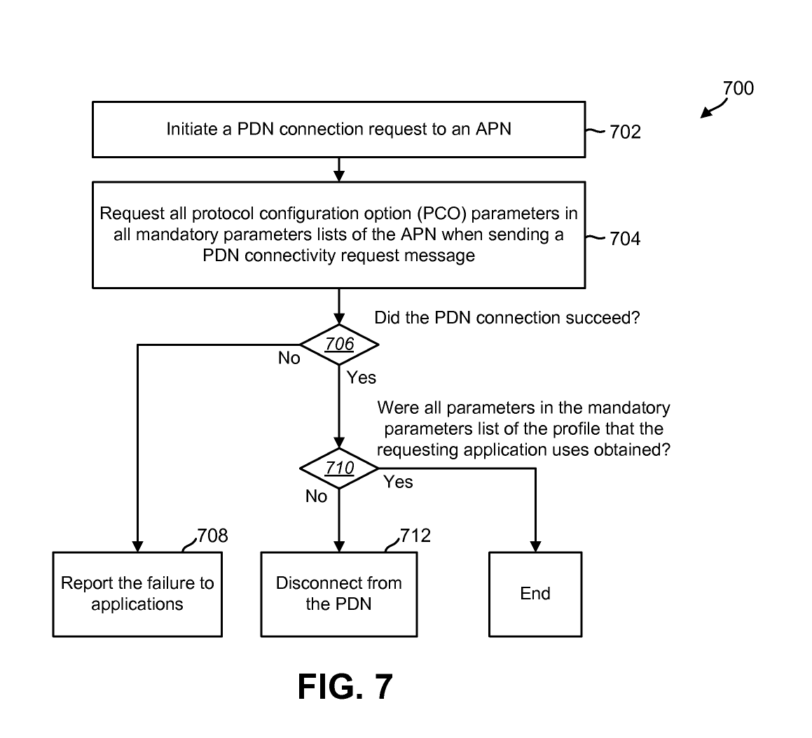

FIG. 7 is a flow diagram of a method 700 for obtaining all parameters in a mandatory parameters list 435 for a profile 439. The method 700 may be performed by a user equipment (UE) 204. Different applications may require different protocol configuration option (PCO) parameters 440. Normally, when requesting a PDN connection, the user equipment (UE) 204 may request the protocol configuration option (PCO) parameters 440 based on the profile 439 that is specified by the application. However, multiple applications may share one PDN connection. For example, if a first application requests a PDN connection, the user equipment (UE) 204 and the network may set up the PDN connection for the first application. If the first application does not require a specific protocol configuration option (PCO) parameter 440, the user equipment (UE) 204 may not request that specific protocol configuration option (PCO) parameter 440 during the PDN connection establishment procedures. If a second application is activated and requests the same PDN, both the first application and the second application may share the existing PDN. However, if the second application requires a protocol configuration option (PCO) parameter 440 not requested, the second application may not be able to obtain services, since the user equipment (UE) 204 has not obtained the protocol configuration option (PCO) parameter 440.

The user equipment (UE) 204 may initiate 702 a PDN connection request to an APN 438. The user equipment (UE) 204 may request 704 all protocol configuration option (PCO) parameters 440 in all mandatory parameters lists 435 of the APN 438 when sending a PDN connectivity request message. The user equipment (UE) 204 may then determine 706 whether the PDN connection was successful. If the PDN connection was not successful, the user equipment (UE) 204 may report 708 the failure to the applications. If the PDN connection was successful, the user equipment (UE) 204 may then determine 710 whether the user equipment (UE) 204 has obtained all the parameters in the mandatory parameters list 435 of the profile 439 that the requesting application uses. If the user equipment (UE) 204 has obtained all the parameters in the mandatory parameters list 435 of the profile 439, the method 700 may end. If the user equipment (UE) 204 has not obtained all the parameters in the mandatory parameters list 435 of the profile 439, the user equipment (UE) 204 may disconnect 712 from the PDN and report 708 a failure to the application.

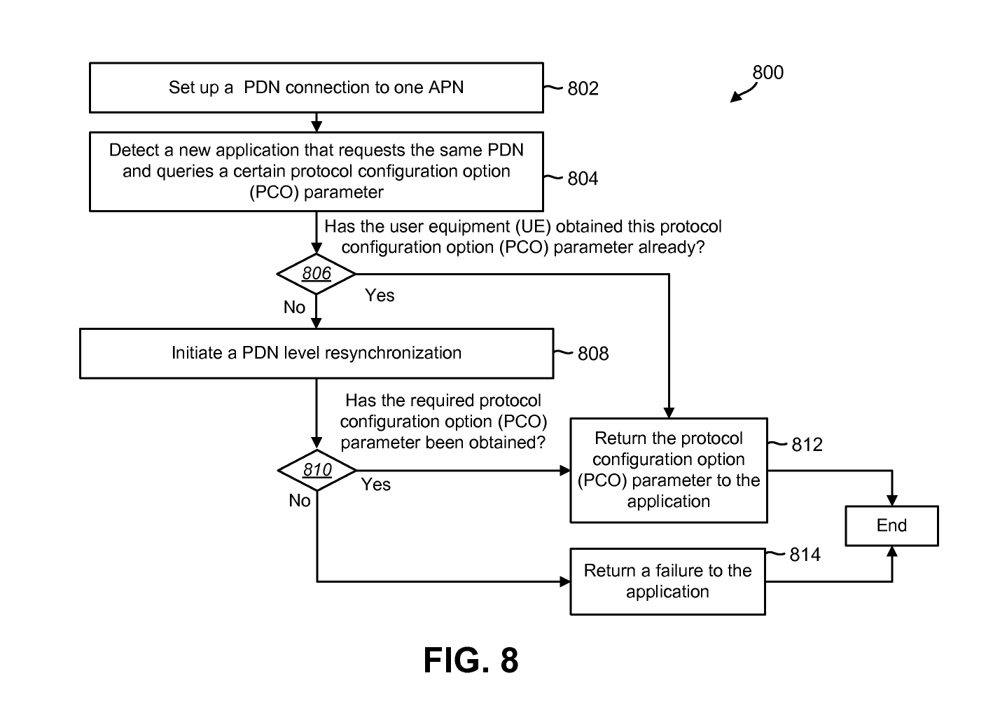

FIG. 8 is a flow diagram of a method 800 for initiating PDN level synchronization. The method 800 may be performed by a user equipment (UE) 204. The user equipment (UE) 204 may set up 802 a PDN connection to one APN. After the user equipment (UE) 204 connects to an APN successfully (and all parameters in the mandatory parameters list 435 for the profile 439 have been assigned by the network), a new application may be detected 804 that requests the same PDN connection and queries a certain protocol configuration option (PCO) parameter 440. The new application may require certain protocol configuration option (PCO) parameters 440 that have not been assigned by the network.

The user equipment (UE) 204 may determine 806 whether the user equipment (UE) 204 has obtained the required protocol configuration option (PCO) parameter 440. If the user equipment (UE) 204 has already obtained the required protocol configuration option (PCO) parameter 440, the user equipment (UE) 204 may return 812 the protocol configuration option (PCO) parameter 440 to the new application.

Upon receiving a query of the missing protocol configuration option (PCO) parameter 440, the user equipment (UE) 204 may initiate 808 a PDN level resynchronization (e.g., Bearer Resource Modification procedures for LTE, vendor-specific network control protocol (VSNCP) resynchronization procedures over eHRPD). The user equipment (UE) 204 may also use other procedures to obtain the required protocol configuration option (PCO) parameters 440, such as a domain name system (DNS) query for a proxy call session control function (P-CSCF) address. The method 800 may apply to PDN connection procedures over other Enhanced Packet Core (EPC) networks 218 (e.g., eHRPD).

The user equipment (UE) 204 may then determine 810 whether the PDN level resynchronization has resulted in the user equipment (UE) 204 obtaining the required protocol configuration option (PCO) parameter 440. If the PDN level resynchronization has resulted in the required protocol configuration option (PCO) parameter 440 being obtained, the user equipment (UE) 204 may return 812 the required protocol configuration option (PCO) parameter 440 to the new application and the method 800 may end. If the PDN level resynchronization does not result in the required protocol configuration option (PCO) parameter 440 being obtained by the user equipment (UE) 204, the user equipment (UE) 204 may return 814 a failure to the new application and the method may end.

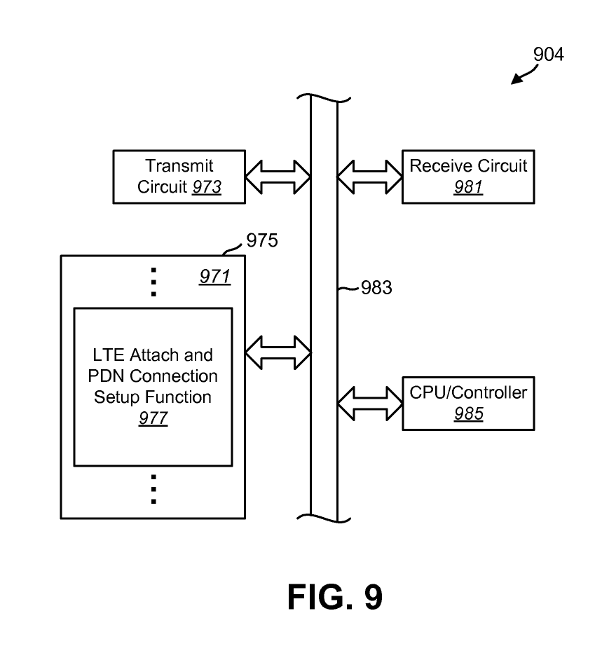

FIG. 9 shows part of a hardware implementation of an apparatus 904 for executing the schemes or processes as described above. The apparatus 904 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like, such as shown and described in FIG. 9.

In this embodiment, the circuit apparatus is signified by the reference numeral 904 and can be implemented in a wireless communication device 104 or user equipment (UE) 204 described above.

The apparatus 904 comprises a central data bus 983 linking several circuits together. The circuits include a CPU (central processing unit) or a controller 985, a receive circuit 981, a transmit circuit 973, and a memory unit 975.

The receive circuit 981 and the transmit circuit 973 can be connected to an RF (radio frequency) circuit (which is not shown in the drawing). The receive circuit 981 processes and buffers received signals before sending the signals out to the data bus 983. On the other hand, the transmit circuit 973 processes and buffers the data from the data bus 983 before sending the data out of the apparatus 904. The CPU/controller 985 performs the function of data management of the data bus 983 and furthers the function of general data processing, including executing the instructional contents of the memory unit 975.

The memory unit 975 includes a set of modules and/or instructions generally signified by the reference numeral 971. In this embodiment, the modules/instructions include, among other things, an LTE attach and PDN connection setup function 977 which carries out the schemes and processes as described above. The function 977 includes computer instructions or code for executing the process steps as shown and described in FIGS. 1-8. Specific instructions particular to an entity can be selectively implemented in the function 977. For instance, if the apparatus 904 is part of a wireless communication device 104, among other things, instructions particular to the wireless communication device 104, as shown and described in FIGS. 1-8 can be coded in the function 977.

In this embodiment, the memory unit 975 is a RAM (Random Access Memory) circuit. The exemplary functions, such as the function 977, include one or more software routines, modules and/or data sets. The memory unit 975 can be tied to another memory circuit (not shown) which can either be of the volatile or nonvolatile type. As an alternative, the memory unit 975 can be made of other circuit types, such as an EEPROM (electrically erasable programmable read only memory), an EPROM (electrical programmable read only memory), a ROM (read only memory), an ASIC (application specific integrated circuit), a magnetic disk, an optical disk, and others well known in the art.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, include compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus configured for wireless communication, comprising:
means for selecting a first attach access point name candidate from an attach access point name list;
means for performing a long term evolution attach using the selected attach access point name;
means for determining whether the long term evolution attach succeeds; and
means for selecting a next attach access point name candidate from the attach access point name list if the long term evolution attach using the first attach access point name candidate fails and causes a change of attach access point name.

2. The apparatus of claim 1, wherein the means for selecting the next attach access point name candidate comprise means for reevaluating the attach access point name list based on a response from a network.

3. The apparatus of claim 1, wherein the attach access point name candidates in the attach access point name list are listed in priority order.

4. The apparatus of claim 1, wherein an operator can provision the attach access point name list.

5. The apparatus of claim 1, wherein the apparatus determines to reset the selected attach access point name to the first attach access point name candidate in the attach access point name list upon acquiring a long term evolution system.

6. The apparatus of claim 1, wherein long term evolution detach is preferred.

7. The apparatus of claim 1, wherein the long term evolution attach succeeds, wherein a network has assigned all parameters in a mandatory parameters list for the selected attach access point name, and wherein the apparatus resets the selected attach access point name to the first item in the attach access point name list and proceeds with subsequent packet data network connection establishment only if all parameters in the mandatory parameters list have been assigned by the network.

8. The apparatus of claim 1, wherein the long term evolution attach succeeds, wherein it is determined that a network has not assigned all parameters in a mandatory parameters list for the selected attach access point name, and wherein the apparatus selects the next attach access point name candidate from the attach access point name list.

9. The apparatus of claim 8, wherein the apparatus detaches from the network, and wherein the apparatus determines whether the apparatus needs to leave long term evolution.

10. The apparatus of claim 1, wherein long term evolution detach is not preferred.

11. The apparatus of claim 10, wherein it is determined that a network has assigned all parameters in a mandatory parameters list, and wherein the apparatus is allowed to initiate additional packet data network establishment procedures.

12. An apparatus, comprising:
circuitry configured to select a first attach access point name candidate from an attach access point name list, to perform a long term evolution attach using the selected attach access point name, to determine whether the long term evolution attach succeeds, and to select a next attach access point name candidate from the attach access point name list if the long term evolution attach using the first attach access point name candidate fails and causes a change of attach access point name.

13. The apparatus of claim 12, wherein selecting the next attach access point name candidate comprises reevaluating the attach access point name list based on a response from a network.

14. The apparatus of claim 12, wherein the access point name candidates in the attach access point name list are listed in priority order.

15. The apparatus of claim 12, wherein an operator can provision the attach access point name list.

16. The apparatus of claim 12, wherein the apparatus determines to reset the selected attach access point name to the first attach access point name candidate in the attach access point name list upon acquiring a long term evolution system.

17. The apparatus of claim 12, wherein long term evolution detach is preferred.

18. The apparatus of claim 12, wherein the long term evolution attach succeeds, wherein a network has assigned all parameters in a mandatory parameters list for the selected attach access point name, and wherein the apparatus resets the selected attach access point name to the first item in the attach access point name list and proceeds with subsequent packet data network connection establishment only if all parameters in the mandatory parameters list have been assigned by the network.

19. The apparatus of claim 12, wherein the long term evolution attach succeeds, wherein it is determined that a network has not assigned all parameters in a mandatory parameters list for the selected attach access point name, and wherein the apparatus selects the next attach access point name candidate from the attach access point name list.

20. The apparatus of claim 19, wherein the apparatus detaches from the network, and wherein the apparatus determines whether the apparatus needs to leave long term evolution.

21. The apparatus of claim 12, wherein long term evolution detach is not preferred.

22. The apparatus of claim 21, wherein it is determined that a network has assigned all parameters in a mandatory parameters list, and wherein the apparatus is allowed to initiate additional packet data network establishment procedures.

23. A method for wireless communication by a user equipment, comprising:
selecting a first attach access point name candidate from an attach access point name list;
performing a long term evolution attach using the selected attach access point name;
determining whether the long term evolution attach succeeds; and
selecting a next attach access point name candidate from the attach access point name list if the long term evolution attach using the first attach access point name candidate fails and causes a change of attach access point name.

24. The method of claim 23, wherein selecting the next attach access point name candidate comprises reevaluating the attach access point name list based on a response from a network.

25. The method of claim 23, wherein the attach access point name candidates in the attach access point name list are listed in priority order.

26. The method of claim 23, wherein an operator can provision the attach access point name list.

27. The method of claim 23, wherein the user equipment determines to reset the selected attach access point name to the first attach access point name candidate in the attach access point name list upon acquiring a long term evolution system.

28. The method of claim 23, wherein it is determined that the long term evolution attach has not succeeded, and further comprising determining whether the failure of the long term evolution attach has caused a change of the attach access point name.

29. The method of claim 28, wherein it is determined that the failure of the long term evolution attach causes a change of the attach access point name, and further comprising:
selecting the next attach access point name candidate from the attach access point name list; and
determining whether the user equipment needs to leave long term evolution.

30. The method of claim 29, wherein it is determined that the user equipment does not need to leave long term evolution, and further comprising again performing a long term evolution attach using the selected attach access point name.

31. The method of claim 28, further comprising:
determining that the failure does not cause a change of the attach access point name; and
determining whether the user equipment needs to leave long term evolution.

32. The method of claim 31, wherein it is determined that the user equipment does not need to leave long term evolution, and further comprising again performing a long term evolution attach using the selected attach access point name.

33. The method of claim 23, wherein long term evolution detach is preferred.

34. The method of claim 33, wherein the long term evolution attach succeeds, wherein a network has assigned all parameters in a mandatory parameters list for the selected attach access point name, and wherein the user equipment resets the selected attach access point name to the first item in the attach access point name list and proceeds with subsequent packet data network connection establishment only if all parameters in the mandatory parameters list have been assigned by the network.

35. The method of claim 33, wherein the long term evolution attach succeeds, wherein it is determined that the network has not assigned all parameters in a mandatory parameters list for the selected attach access point name, and wherein the user equipment selects the next attach access point name candidate from the attach access point name list.

36. The method of claim 35, wherein the user equipment detaches from the network, and wherein the user equipment determines whether the user equipment needs to leave long term evolution.

37. The method of claim 36, wherein it is determined that the user equipment does not need to leave long term evolution, and further comprising again performing a long term evolution attach using the selected attach access point name.

38. The method of claim 23, wherein long term evolution detach is not preferred.

39. The method of claim 38, wherein it is determined that the long term evolution attach succeeds, and further comprising:
resetting the first attach access point name candidate as the selected attach access point name; and
determining whether a network has assigned all parameters in a mandatory parameters list for the selected attach access point name.

40. The method of claim 39, wherein it is determined that the network has assigned all parameters in the mandatory parameters list, and wherein the user equipment is allowed to initiate additional packet data network establishment procedures.

41. The method of claim 39, wherein it is determined that the network has not assigned all parameters in the mandatory parameters list, and further comprising determining whether the user equipment has already attempted to connect to all attach access point name candidates in the attach access point name list.

42. The method of claim 41, wherein it is determined that the user equipment has already attempted to connect to all attach access point name candidates in the attach access point name list, and further comprising:
detaching from the network; and
determining whether the user equipment needs to leave long term evolution.

43. The method of claim 42, wherein it is determined that the user equipment does not need to leave long term evolution, and further comprising again performing a long term evolution attach using the selected attach access point name.

44. The method of claim 41, wherein it is determined that the user equipment has not attempted to connect to all attach access point name candidates in the attach access point name list, and further comprising:
autonomously connecting to the next attach access point name candidate in the attach access point name list; and
determining whether the connection has succeeded and the network has assigned all the parameters in a mandatory parameters list for the next attach access point name candidate.

45. The method of claim 44, wherein it is determined that the connection has not succeeded and the network has not assigned all the parameters in the mandatory parameters list, and further comprising again determining whether the user equipment has attempted to connect to all attach access point name candidates in the attach access point name list.

46. The method of claim 44, wherein it is determined that the connection has succeeded and the network has assigned all the parameters in the mandatory parameters list, and further comprising disconnecting from an attach packet data network, wherein the user equipment is allowed to initiate additional packet data network establishment procedures.

47. The method of claim 23, further comprising obtaining all parameters in a mandatory parameters list for a profile, wherein obtaining all parameters in a mandatory parameters list for a profile comprises:
requesting a packet data network connection;
requesting all protocol configuration option parameters listed in all mandatory parameters lists for the selected attach access point name; and
disconnecting from the packet data network if any of the parameters in the mandatory parameters list for a current profile have not been assigned by a network.

48. The method of claim 23, further comprising:
receiving a query of missing protocol configuration option parameters; and
initiating a packet data network level resynchronization.

49. A computer-program product, the computer-program product comprising a non-transitory computer-readable medium having instructions thereon, the instructions comprising:
code for causing a wireless device to select a first attach access point name candidate from an attach access point name list;
code for causing the wireless device to perform a long term evolution attach using the selected attach access point name;
code for causing the wireless device to determine whether the long term evolution attach succeeds; and
code for causing the wireless device to select a next attach access point name candidate from the attach access point name list if the long term evolution attach using the first attach access point name candidate fails and causes a change of attach access point name.

50. The computer-program product of claim 49, wherein the code for causing the wireless device to select the next attach access point name candidate comprises code for causing the wireless device to reevaluate the attach access point name list based on a response from a network.

51. The computer-program product of claim 49, wherein the attach access point name candidates in the attach access point name list are listed in priority order.

52. The computer-program product of claim 49, wherein an operator can provision the attach access point name list.
